(19) United States
(12) Patent Application Publication
(10) Pub. No.: US 2026/0078622 A1
(43) Pub. Date: Mar. 19, 2026

(54) ARCH-TOP, PIVOT-DOOR, OFFSET-HINGE ATTACHMENT

(71) Applicant: Todd Noe, Del Mar, CA (US)

(72) Inventor: Todd Noe, Del Mar, CA (US)

(21) Appl. No.: 18/889,879

(22) Filed: Sep. 19, 2024

(51) Int. Cl. E05D 11/00

(52) U.S. Cl. CPC E05D 11/0054

(57) ABSTRACT

The invention is a metal component attached to a pivot hinge, which aids in fabrication, and improves the aesthetic as well as functionality of an arch-top, offset, pivot door-system.

### TECHNICAL FIELD

The invention is a metal attachment attached to a pivot hinge on a pivot door.

### BACKGROUND OF INVENTION

Arch-top pivot doors have been around for thousands of years.

Conventional arch-top pivot doors are designed out of metal, wood and a variety of other materials, but all require some form of hinging system in order to provide smooth open-and-close operation.

### BRIEF DESCRIPTION OF THE INVENTION

The invention is a metal component which attaches to the arch, and pivot hinge, of an arch-top door.

This attachment acts as a partial fabrication template, as well as, an aesthetic improvement of a pivot door.

This attachment provides the location where the offset pivot hinge will be installed on the door and jamb, and facilitates the proper drilling of the receiving hole for the pivot hinge in the arches of the arch-top door and jamb in the desired location.

A first aesthetic improvement is a clean profile of the door jamb without any cut outs where the pivot hinge is located on the exterior side of the door system.

A second aesthetic improvement is consistent tight spacing for the gap between the jamb and door on both the interior and exterior sides.

The invention is a hollow metal shell component comprising a rectangular front-on profile with a cut out that matches the arc of the arch-top door to which it will be attached, thereby spanning from the top of one corner to the bottom corner of the opposite side.

On the side of the top-down profile, where the arc cut out terminates on the lower corner of the front-on profile, there is a circular cut out that allows the shaft of the pivot hinge to slide through the attachment and securely attach to the jamb so as to provide the open and closing motion.

Enclosing the attachment component on the side where the arc cut-out terminates on the lower corner of the front-on profile is a half round that matches the curvature of the circular cut-out on the top-down profile. This enables the door system to fully open and close in a smooth fashion while still maintaining a consistent gap between the door and jamb.

By maintaining a tight gap between the door and jamb, the functional insulation quality of the door system is improved.

### BRIEF DESCRIPTION OF DRAWINGS

FIG. 1 shows the pivot hinge attachment and its overall form.

FIG. 2 shows an exploded view of the attachment above its location on the door.

FIG. 3 shows an assembled view of the attachment and the door with the receiving hole drilled into the door with the attachment as the drilling template.

FIG. 4 shows an exploded view of the receiving pivot hinge hardware above the pivot hinge attachment receiving hole.

FIG. 5 shows an assembled view of the receiving pivot hinge hardware integrated into the pivot hinge attachment and the door.

FIG. 6 illustrates how the pivot hinge attachment assembled on the door slots into the desired jamb notch.

FIG. 7 shows an exploded view of the top portion of the hinge above the desired location of the receiving hole on the jamb.

FIG. 8 illustrates how the top half of the pivot hinge is assembled within the jamb's receiving cut out.

FIG. 9 shows an assembled view of the door, jamb, pivot hinge attachment and pivot hinge hardware.

FIG. 10a shows a fully assembled arch-top door from the exterior side.

FIG. 10b shows a close up of how the pivot attachment assembly appears from the exterior side of the arch-top door.

FIG. 10c shows a close up of how the pivot attachment assembly appears from the interior side of the arch-top door.

### DETAILED DESCRIPTION OF INVENTION

Arch-top pivot doors have been around for thousands of years. Conventional arch-top pivot doors are designed out of metal, wood and a variety of other materials, but all require some form of hinging system in order to provide a smooth open-and-close operation.

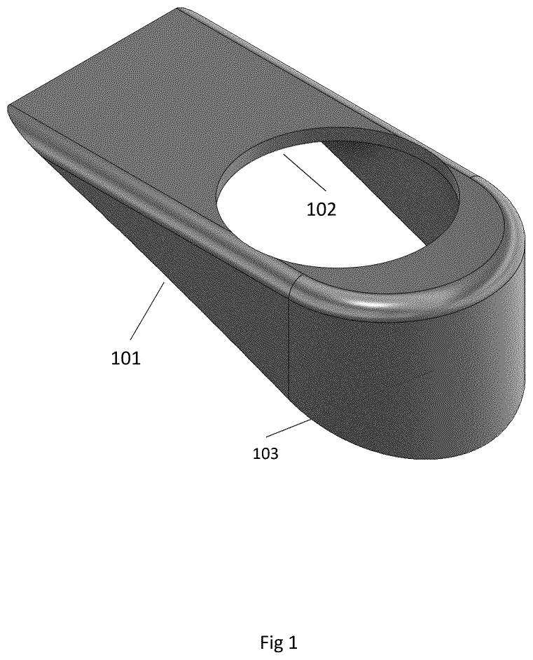

FIG. 1 illustrates a hollow metal shell component with a cut out that matches the arc of the arch-top door (101) where it will be attached to span from the top of one corner to the bottom of the opposite side's bottom corner.

FIG. 1 also illustrates the location of a circular cut out (102) that allows the shaft of the pivot hinge to slide through the attachment and securely attach to the jamb and support the open and closing motion.

FIG. 1 depicts a half round (103) that matches the curvature of the circular cut enclosing the attachment component on the side where the arc cut out terminates on the lowest corner of the front-on profile. This enables the door system to fully open and close in a smooth fashion while still maintaining a consistent gap between the door and jamb.

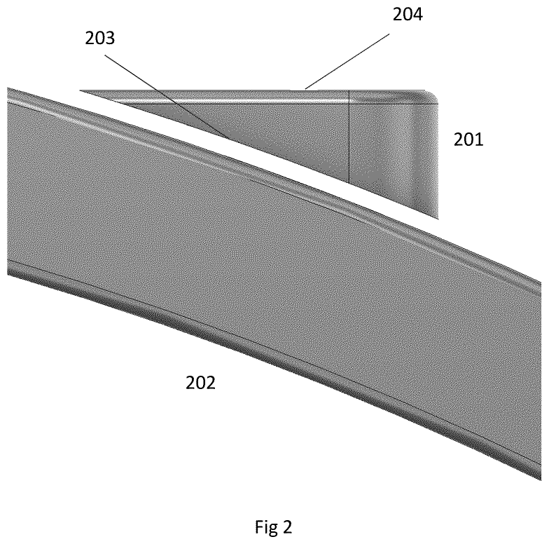

FIG. 2 illustrates a side view of the attachment component (201) in its proper location above the door (202), where the arch cut out (203) would attach to the arch of the door (202) in a way where the top face of the pivot hinge attachment (204) would be level.

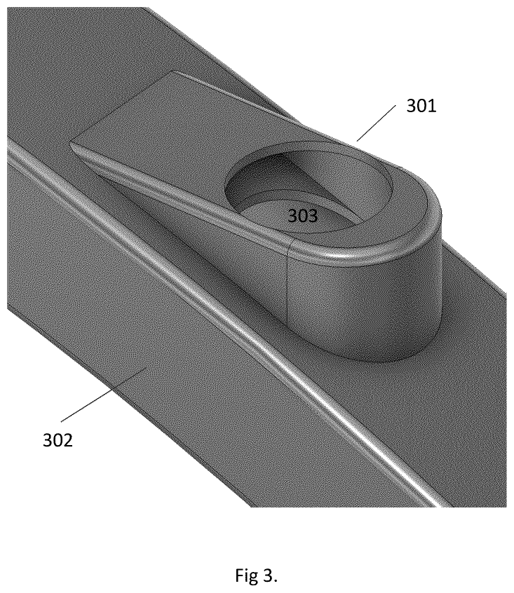

FIG. 3 illustrates how the pivot hinge attachment (301) would appear once it is fully welded to the arch on the arch-top door (302). Furthermore, FIG. 3 portrays the receiving hole (303) for the pivot hinge hardware that would be drilled into the arch of the arch-top door (302) with the aid of the pivot hinge attachment (301) acting as a drilling template once it is attached.

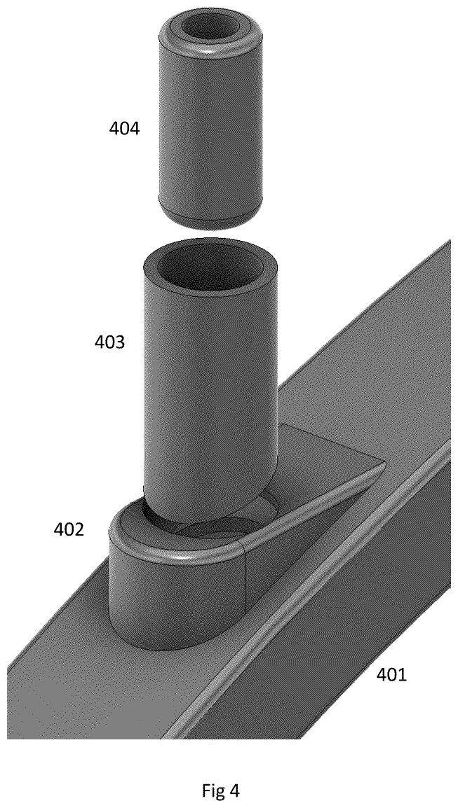

FIG. 4 shows an exploded view of the bottom half of the pivot hardware (404) and the Drawn-Over-Mandrel (DOM) mechanical tubing sleeve (403) it slots into before being integrated and welded into the pivot hinge attachment (402) and arch of the arch-top door (401).

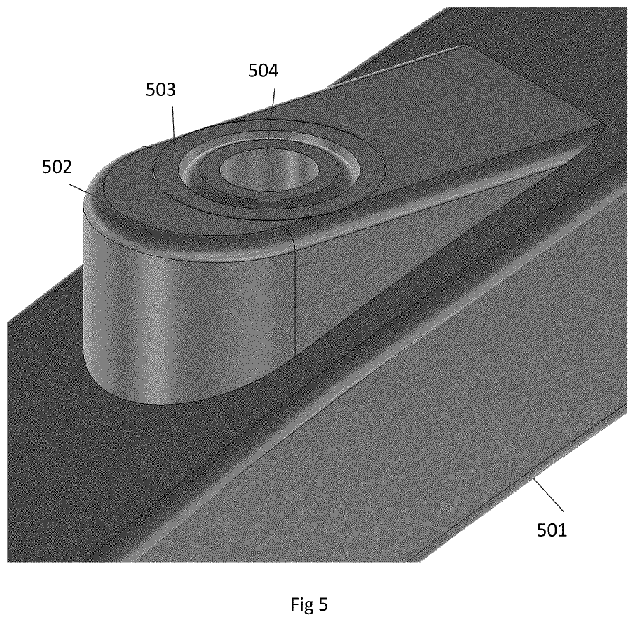

FIG. 5 illustrates the assembly of the bottom half of the pivot hardware, (504) and its DOM sleeve (503), in the pivot hinge attachment (502) and arch of the arch-top door (501) which is then welded in place.

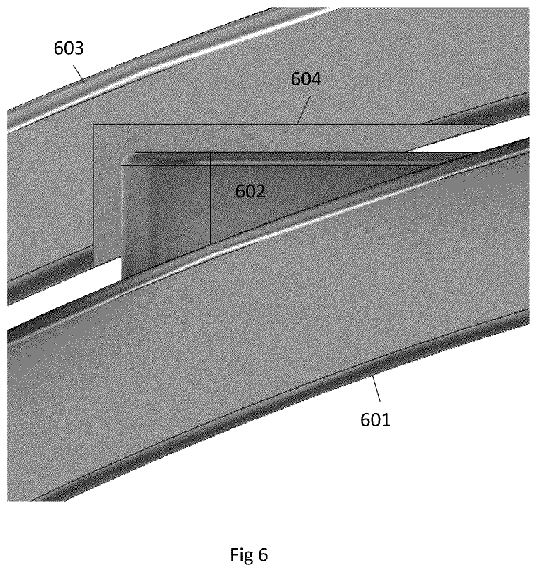

FIG. 6 portrays a side view of the arch of the arch-top door (601) with the integrated pivot hinge attachment (602), and how both fit inside the jamb (603), with the pivot hinge attachment (602) sitting within the fabricated jamb notch (604)

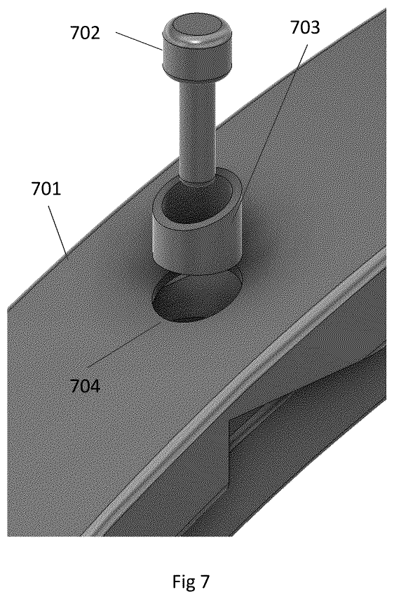

FIG. 7 shows an exploded view of the top half of the pivot hinge (702) and its respective DOM sleeve (703), before being integrated and welded into the receiving cut out (704) of the arch of the jamb of the arch-top door system (701).

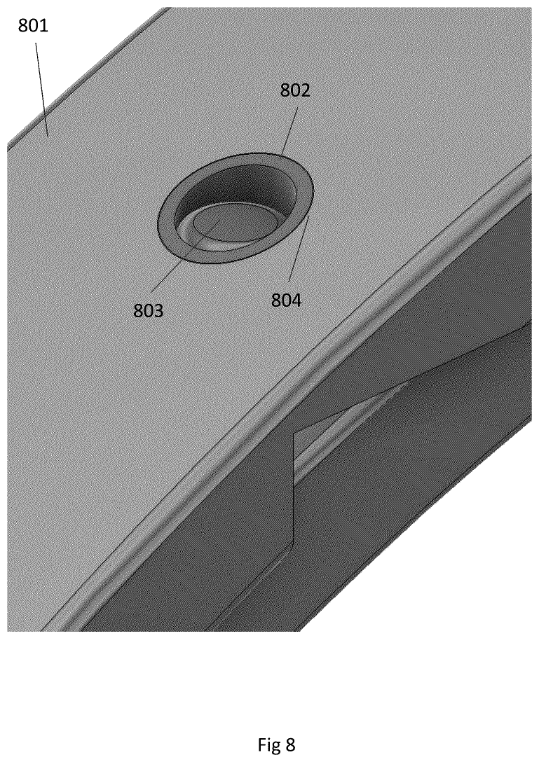

FIG. 8 illustrates the assembly of the top half of the pivot hardware, (802) and its DOM sleeve (803) in the receiving cut out (804) of the arch of jamb, (801), which is then welded in place.

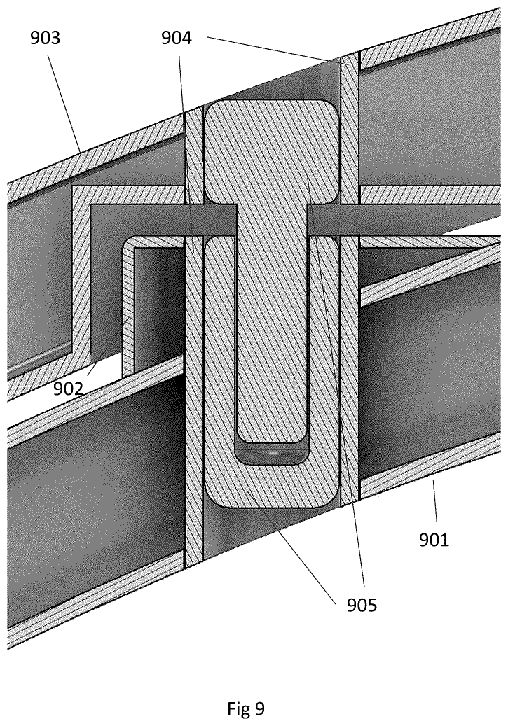

FIG. 9 shows a side view cross section of the entire assembly of the arch-top offset pivot hinge door system including the arch-top door (901), pivot hinge attachment component (902), jamb (903), DOM sleeves (904), and pivot-hinge hardware (905).

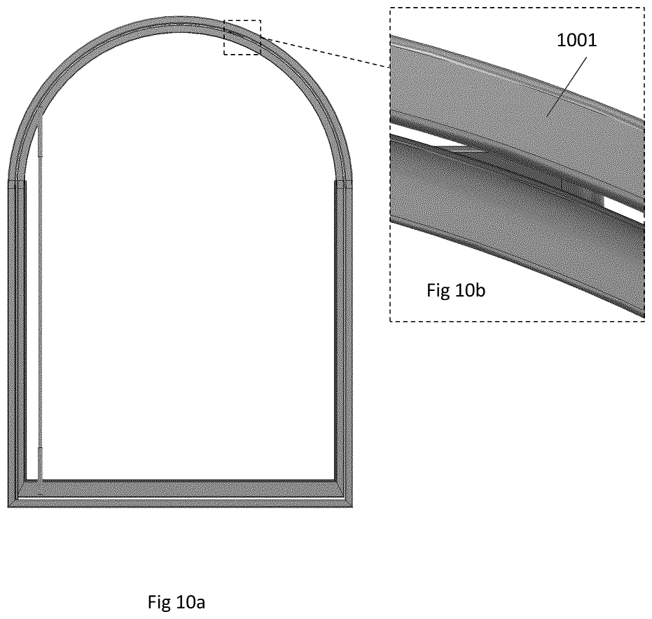

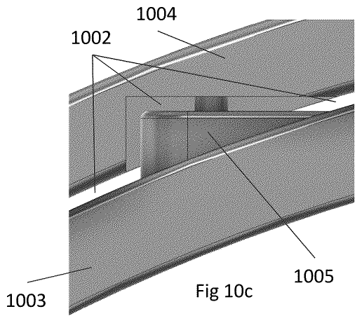

FIG. 10a shows an arch-top pivot-door system with the pivot hinge attachment in its entire assembly.

FIG. 10b shows a close up of the entire pivot-hinge assembly wherein an un-notched jamb (1001) is seen from the exterior side of the door.

FIG. 10c shows a close up of the entire pivot-hinge assembly wherein from the interior side of the door there is consistent spacing of the gap (1002) between the door (1003), jamb (1004) and pivot-hinge attachment (1005).

What is claimed is:

1. A hollow, metal-shell, attachment component comprising:
a rectangular front-on profile with a cut out that spans from a top of one corner to a bottom corner of the opposite side of the rectangular profile;
a circular cut-out on the top-down profile; and
an enclosing half-round extrusion on a side of the hollow, metal-shell, attachment component where the arc cut-out terminates on a lower corner of the front on profile.

2. A claim as in claim 1 wherein:
the arc cut-out matches a corresponding arch of the arch-top door such that the hollow, metal-shell, attachment component attaches to the arch where a top surface of the component is level and the arc cut-out is flush to an arch of the arch-top pivot door.

3. A claim as in claim 1 wherein:
the circular cut-out on the top-down profile of the hollow, metal-shell attachment component acts as a drilling template for a receiving cut-out on the door, where the bottom half of a pivot hinge is welded into place; and
the circular cut-out allows for the shaft of the pivot hinge to pass through the hollow-metal-shell attachment component and connect at a bottom-half of the pivot hinge.

4. A claim as in claim 1 wherein:
the enclosing half-round extrusion enables the door to pivot open and closed uniformly while maintaining a tight spacing of a gap between the door and jamb.

5. A method of use claim comprising:
aligning a hollow, metal-shell, attachment component to an arch in which a top surface of the hollow, metal-shell attachment component is level, and the arc cut-out is flush to an arch of an arch-top pivot door;
welding the hollow, metal-shell, attachment component into a desired location using a circular cut-out on the hollow, metal-shell, attachment component's top-down profile to guide drilling of circular cut-outs into the arch of the arch-top pivot door;
placing the arch-top pivot door into a jamb so that the hollow, metal-shell attachment component sits within a prefabricated notch on an interior side of the jamb; and
assembling, integrating and welding pivot hardware into respective receiving cut-outs pre-determined by the hollow, metal-shell, attachment component's circular cut out.
